(19) United States
(12) Patent Application Publication
(10) Pub. No.: US 2004/0264870 A1
(43) Pub. Date: Dec. 30, 2004

(54) Optical alignment mount with height adjustment

(76) Inventors: Timothy A. Skunes, Mahtomedi, MN (US); John P. Konicek, Minneapolis, MN (US); Michael Knipfer, Maple Grove, MN (US)

Correspondence Address: Judson K. Champlin, WESTMAN, CHAMPLIN & KELLY, P.A., Suite 1600 - International Centre, 900 Second Avenue South, Minneapolis, MN, 55402-3319, US

(21) Appl. No.: 10/644,650

(22) Filed: Aug. 20, 2003

Related U.S. Application Data
(60) Provisional application No. 60/405,011, filed on Aug. 20, 2002.
(60) Provisional application No. 60/404,865, filed on Aug. 20, 2002.

(51) Int. Cl. G02B 6/26

(52) U.S. Cl. 385/52

(57) ABSTRACT

An optical alignment mount for adjusting a height of an optical component includes a component mount adapted to receive an optical component. A height of the optical component in the mount can be adjusted and fixed as desired.

The present application is based on and claims the benefit of U.S. provisional patent application Ser. No. 60/405,011, filed Aug. 20, 2002, and provisional patent application Ser. No. 60/404,865, filed Aug. 20, 2002, the contents of which are hereby incorporated by reference in their entirety.

### BACKGROUND OF THE INVENTION

The present invention relates to optical components. More specifically, the invention relates to alignment of optical components.

Fiber optic communication systems allow data transfer at tremendous rates over long distances. For high performance, it is important to efficiently couple light between optical components used in these systems. Efficient coupling of light between optical components in fiber optic communication systems requires precision adjustment, alignment, and securing of the components, often to a tolerance level of less than 1 micron. Fiber alignment problems are appreciated in the art and substantial efforts have been made to address them. Numerous alignment mounts and securing methods are disclosed in the prior art. These methods include laser welding, soldering, and using adhesive to secure the alignment mounts.

U.S. Pat. No. 5,619,609 discloses a clip and sleeve system that facilitates alignment and subsequent securing of an optical fiber by laser welding. U.S. Pat. No. 6,184,987 discloses a process for fine adjustment of the alignment of an optical fiber after the fiber has been initially secured by laser welding. Subsequent laser welds shift the position of the clip in a process known as “laser hammering” and allow fine adjustments of the optical fiber. Alternatively, after initial alignment and securing by laser welding, fine adjustments of the fiber may be made by mechanically deforming the clip.

U.S. Pat. No. 6,222,579 discloses a method of aligning an optical component that uses a quantity of solder that exceeds the required adjustment range. The optical component is aligned while the solder is molten and secured by allowing the solder to solidify. U.S. Pat. No. 6,470,120 discloses a dual eccentric sleeve alignment system that is rotated to achieve epicyclic motion. U.S. Pat. No. 6,174,092 discloses a method for aligning optical fibers that uses a slanted, planar fiber adapter. The fiber adapter engages a similarly slanted, planar base member to minimize the amount of solder.

Although there has been some success using prior art mounts and securing methods such as laser welding, soldering and using adhesive to secure alignment mounts, there still exists a need for an optical alignment mount that allows height adjustment and minimizes “post-bond shift” during the securing process. “Post-bond shift” occurs due to dimensional changes of the bonding material or mounting structures during the fixing or securing process. Accordingly, there is a need for an optical alignment mount that has height adjustability and minimizes post-bond shift errors.

### SUMMARY OF THE INVENTION

An optical alignment mount for adjusting a height of an optical component includes a component mount adapted to receive an optical component. A height of the optical component in the mount can be adjusted and fixed as desired.

### BRIEF DESCRIPTION OF THE DRAWINGS

FIG. 1 is a perspective view of an optical alignment mount.

FIGS. 2A, 2B, and 2C are front elevational views of the optical alignment mount of FIG. 1 showing height adjustment of an optical fiber.

FIG. 3 is a top plan view of the optical alignment mount of FIG. 1 adjusted to couple light from a laser into an optical fiber.

FIG. 4 is a side elevational view of the optical alignment mount of FIG. 1 adjusted to couple light from a laser into and optical fiber.

FIG. 5 is a perspective view of a fiber optic laser source.

FIG. 6 is a front elevational view of a laser welded optical alignment mount.

FIG. 7 is an exploded perspective view of another aspect of an optical alignment mount.

FIG. 8 is a front elevational view of the optical alignment mount of FIG. 7.

FIG. 9 is a bottom plan view of the pivot support of FIGS. 7 and 8.

FIG. 10 is a front elevational view of an optical alignment mount where a pivot surface engages a base directly.

### DETAILED DESCRIPTION OF THE PREFERRED EMBODIMENTS

The present invention relates to the precision alignment of optical components. More specifically, the present invention provides an improved optical alignment mount with height adjustment. As used herein, “height” is a distance in a direction away from a support structure which may in some embodiments, comprise a substrate. Optical components such as a fibers, lenses, collimators, and detectors may be raised or lowered during alignment by rotating, pivoting, or tilting an appropriate optical component mount within the optical alignment mount. Solid support between the various elements of the optical alignment mount is maintained during this height adjustment as well as the alignment of the optical component in other degrees of freedom. Accordingly, alignment errors caused by post-bond shifting, that invariably occur during securing due to dimensional changes of the bonding material are substantially reduced. In another aspect, very thin layers of bonding material are applied between the various elements of the optical alignment mount. Due to the thinness of the bonding material, post-bond shifts that occur during securing are again reduced substantially.

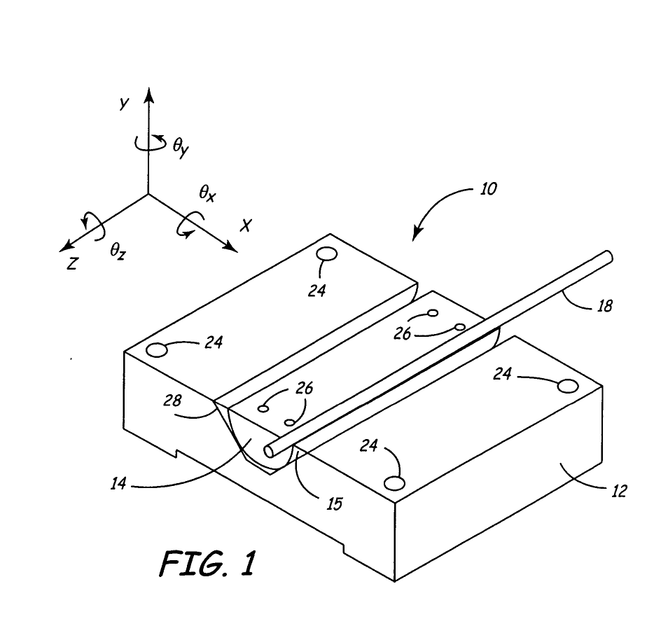

FIG. 1 is a perspective view of optical alignment mount 10. Example optical component, fiber 18, is attached to component mount 14. Component mount 14 has a cylindrically shaped pivot surface 15 that engages v-shaped socket 28 of pivot support 12. Gripping features 26 in component mount 14 may comprise holes or other shapes that aid a gripper or manipulator to position and align component mount 14. Gripping features 24 in pivot support 12 may comprise holes or other shapes that aid a gripper or manipulator to position and align pivot support 12.

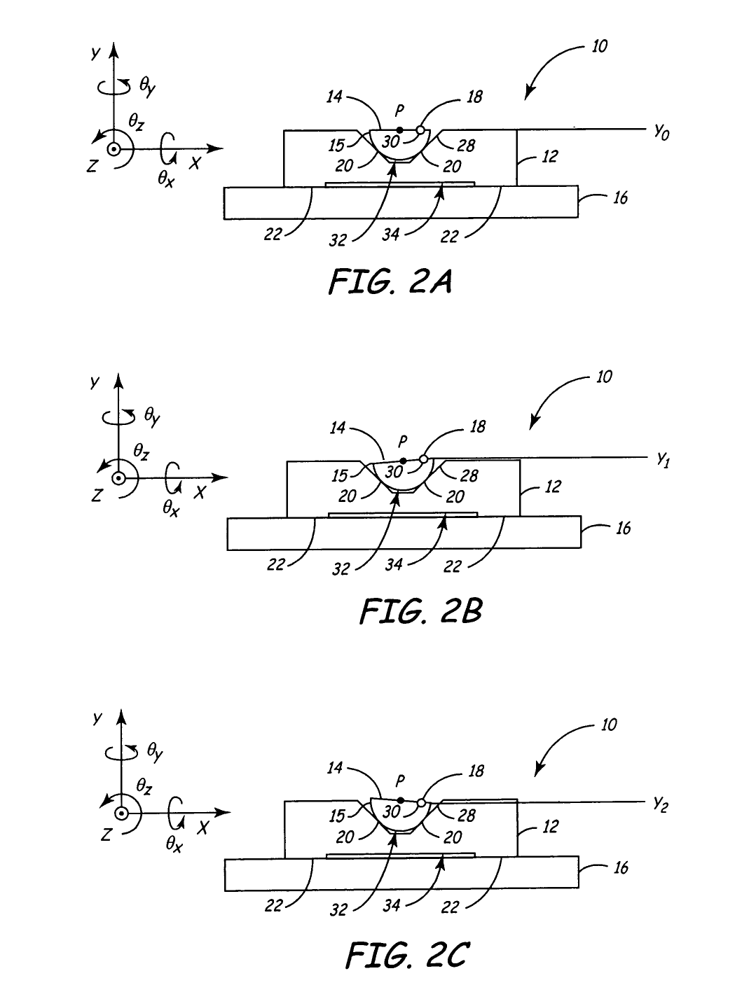

FIGS. 2A, 2B, and 2C illustrate how the height of fiber 18 may be raised or lowered in the Y direction by rotating component mount 14 in the θ_{Z} direction. In FIG. 2A the core of fiber 18 is at height Y₀ and offset from the pivot position P of component mount 14. Pivot position P is a line extending in and out of the plane of FIGS. 2A, 2B, and 2C and is at the center of curvature of pivot surface 15. By rotating component mount 14 in the positive θ_{Z} direction as shown in FIG. 2B, component mount 14 pivots about pivot position P and the core of fiber 18 is raised to height Y₁. By rotating component mount 14 in the negative θ_{Z} direction as shown in FIG. 2C, the core of fiber 18 is lowered to height Y₂. The core position of fiber 18 may be adjusted in the X and Z directions by translating pivot support 12 with respect to base 16 in the X and Z directions, respectively. The θ_{Y} alignment of fiber 18 may be adjusted by rotating pivot support 12 with respect to base 16 about the Y axis. V-groove 30 in component mount 14 supports fiber 18. The θ_{Z} alignment of fiber 18 may be adjusted by rotating fiber 18 in the v-groove 30 about the Z axis before fiber 18 is secured to component mount 14.

Pivot surface 15 of component mount 14 engages v-shaped socket 28 along two contact lines 20. As component mount 14 rotates about pivot position P, contact lines 20 are maintained as shown in FIGS. 2A, 2B, and 2C. Contact lines 20 support component mount 14 and a solid support is formed between socket 28 and pivot surface 15. Bonding material, such as epoxy or solder may be applied in gap 32 between component mount 14 and socket 28. Since pivot surface 15 engages socket 28 at contact lines 20, any shrinkage of bonding material acts to tightly secure component mount 14 to socket 28. However, the shrinkage of the bonding material has a negligible affect on the alignment of fiber 18 since there is already solid support between pivot surface 15 and v-groove 28.

Pivot support 12 contacts base 16 at two contact planes 22 maintaining solid support between pivot support 12 and base 16. Bonding material, such as epoxy or solder may be applied in gap 34 between pivot support 12 and base 16. Since pivot support 12 is supported on base 16 at contact planes 22, any shrinkage of bonding material acts to tightly secure pivot support 12 to base 16. However, the shrinkage of the bonding material has a negligible affect on the alignment of fiber 18 since there is already solid support between pivot support 12 and base 16. In another aspect, base 16 may have raised protrusions to support pivot support 12 and still maintain gap 34. In a further aspect, three small, flat pedestals or three small spherical protrusions may be formed in either pivot support 12 or base 16 to maintain gap 34 and support pivot support 12 on base 16.

Pivot surface 15 may be secured to socket 28 and pivot support 12 may be secured to base 16 by appropriate bonding materials such as adhesive or solder. Component mount 14, pivot support 12 and base 16 may be transparent to allow appropriate radiation to secure pivot surface 15 to socket 28 and pivot support 12 to base 16 such as with adhesive or by laser soldering. Component mount 14, pivot support 12, and base 16 may be of appropriate materials or a combination of materials, such as metal, glass, ceramic, semiconductor, or plastic and have coatings to facilitate bonding. Pivot support 12 could include a curved pivot surface and component mount 14 could be configured with a socket that allows component mount 14 to pivot and allow height adjustment of fiber 18. Component mount 14, pivot support 12, and base 16 may also be made by molding.

In another aspect, a very thin layer of bonding material may be applied at contact lines 20 and contact planes 22. The thin layer of bonding material may act as a lubricant between pivot surface 15 and socket 28, and pivot support 12 and base 16, respectively, to promote ease of adjustment. The layer of bonding material should be thin so that dimensional changes of the bonding layer during curing or fixing are smaller than the final alignment accuracy requirement. In this aspect, the thickness of the bonding layer is much smaller than the range of Y direction height adjustability of optical alignment mount 10.

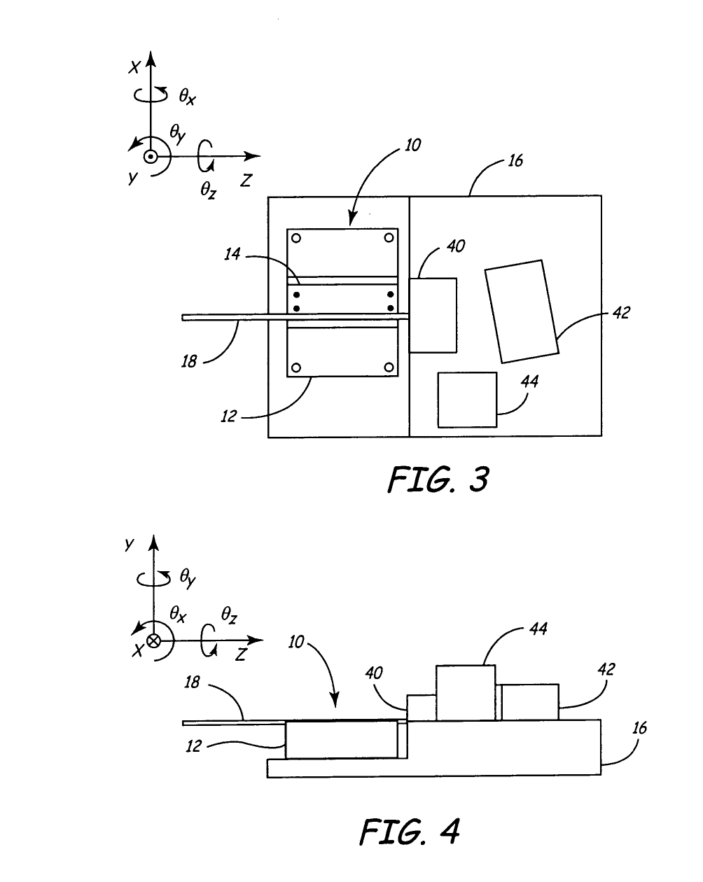

An example fiber optic laser source that advantageously employs the optical alignment mount 10 is illustrated in FIGS. 3-5. However, the present invention is applicable to other optical devices and other types of optical components.

FIG. 3 is a top plan view of base 16 and FIG. 4 is a side elevational view of base 16. Laser 40, monitor photodiode 42, and thermistor 44 are also mounted to base 16. For high coupling efficiency of laser 40 output into optical fiber 18, laser 40 may be energized and the core of fiber 18 may be actively aligned with respect to the emission facet of laser 40. The output of fiber 18 is sensed by a detector (not shown) and fiber 18 may be aligned in the X, Y, Z, θ_{Y} and θ_{Z} directions as discussed above in reference to FIGS. 2A, 2B, and 2C in order to optimize light coupling between laser 40 and fiber 18. The tip of fiber 18 may also be shaped to form a lens in order to improve coupling efficiency.

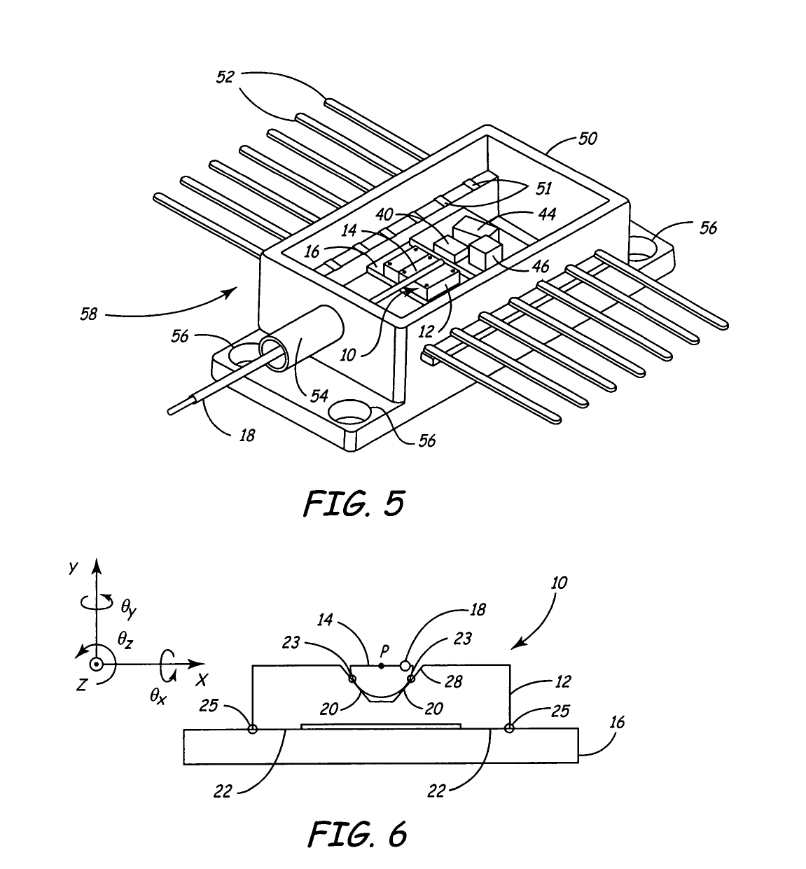

A perspective view of fiber optic laser source 58 is shown in FIG. 5. Base 16 is mounted in package 50. Electrical leads 52 provide connections to external electrical circuitry needed to operate laser source 58. Wire bond pads 51 in package 50 allow wire bonds to electrically connect laser 40, monitor photodiode 44, and thermistor 46 to electrical leads 52. Fiber 18 is fed through ferrule 54. Holes 56 allow for mounting of laser source 58. A lid may soldered, welded, or adhesive bonded to seal the top of package 50 and a seal of glass, solder, or adhesive may be formed between fiber 18 and ferrule 54.

In a further aspect, component mount 14, pivot support 12, and base 16 may be made of appropriate materials such as stainless steel or Kovar and laser welded together, such as with a pulsed Nd:YAG laser. Fillet welds may be formed at weld locations 23 and 25 as shown in FIG. 6. Preferably, weld locations 23 are made simultaneously and equal energy and energy density is applied to weld locations 23. This reduces any shifting of component mount 14 relative to pivot support 12 as the weld pools cool. Preferably, weld locations 25 are also made simultaneously and equal energy and energy density is applied to weld locations 25. This reduces any shifting of pivot support 12 relative to base 16 as the weld pools cool.

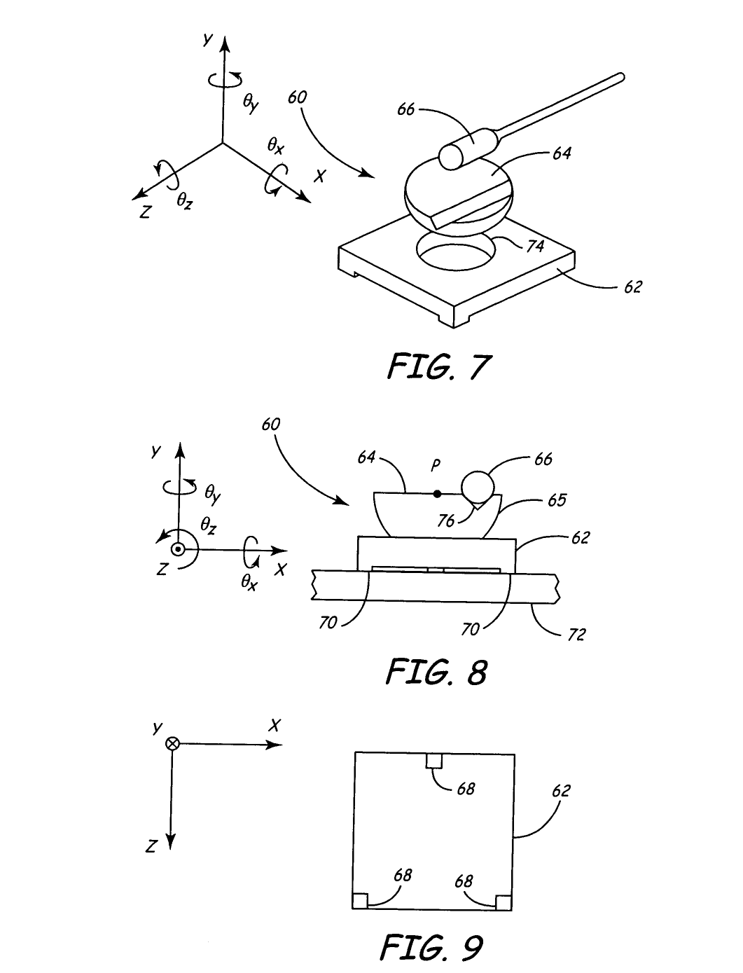

As discussed above, the position of optical fiber 18, or other optical elements, may be adjusted in the X, Y, Z, θ_{Y}, and θ_{Z} directions using optical alignment mount 10 to maintain solid support. Another embodiment of the present invention is shown in FIGS. 7-9 that additionally allows an optical element, such as a fiber optic collimator, to be adjusted in the θ_{X} direction and maintain solid support. FIG. 7 is an exploded perspective view of optical alignment mount 60 and FIG. 8 is a front elevational view of optical alignment mount 60. Example optical component, fiber optic collimator 66, is secured to component mount 64 using v-groove 76 or other suitable mounting technique. Fiber optic collimator 66 is offset from pivot position P of component mount 64. Component mount 64 has a spherically shaped pivot surface 65 that engages pivot support 62 and allows component mount 64 to swivel or rotate about pivot position P in the θ_{Y}, θ_{Y}, and θ_{Z} directions. In this aspect, pivot position P is a point at the center of curvature of pivot surface 65. Pivot support 62 is shown having a hole-shaped socket 74 that engages pivot surface 65. Socket 74 may also be chamfered or a conical shaped depression that allows component mount 64 to swivel in the θ_{X}, θ_{Y}, and θ_{Z} directions. Pivot surface 65 makes a circular line contact with pivot support 62. FIG. 9, which is a bottom plan view of pivot support 62, shows three small pedestals 68 on the bottom of pivot support 62 that contact base 72.

The height of collimator 66 is adjusted in the Y direction by rotating component mount 64, about pivot position P, in the θ_{Z} direction. Collimator 66 is adjusted in the X and Z directions by translating pivot support 62 relative to base 72 in the X and Z directions, respectively. Adjustment in the θ_{X} and θ_{Y} directions is accomplished by rotating component mount 64 in the θ_{X} and θ_{Y} directions, respectively. Collimator 66 may be adjusted in the θ_{Z} direction by rotating collimator 66 in v-groove 76 before collimator 66 is secured to component mount 64.

Pivot surface 65 may be secured to socket 74 and pivot support 62 may be secured to base 72 by appropriate bonding material such as adhesive or solder. Component mount 64, pivot support 62, and base 72 may be transparent to allow appropriate radiation to secure pivot surface 65 to socket 74 and pivot support 62 to base 76 such as with adhesive or by laser soldering. Component mount 64, pivot support 62, and base 72 may be of appropriate materials, or a combination of materials, such as metal, glass, ceramic, semiconductor, or plastic and have coatings to facilitate bonding. Component mount 64, pivot support 62, and base 76 may also be made by molding. Pivot support 62 could include a curved pivot surface and component mount 64 could be configured with a socket that allows component mount 64 to pivot and allow height adjustment of fiber optic collimator 66. A very thin layer of bonding material may be optionally applied at the support location between pivot surface 65 and socket 74 and support location 70 between pedestals 68 and base 72. The thin layer of bonding material may act as a lubricant to promote ease of adjustment. The layer of bonding material should be thin so that dimensional changes of the bonding layer during curing or fixing are smaller than the final alignment accuracy requirement. The thickness of the bonding layer is much smaller than the range of Y direction height adjustability of optical alignment mount 60.

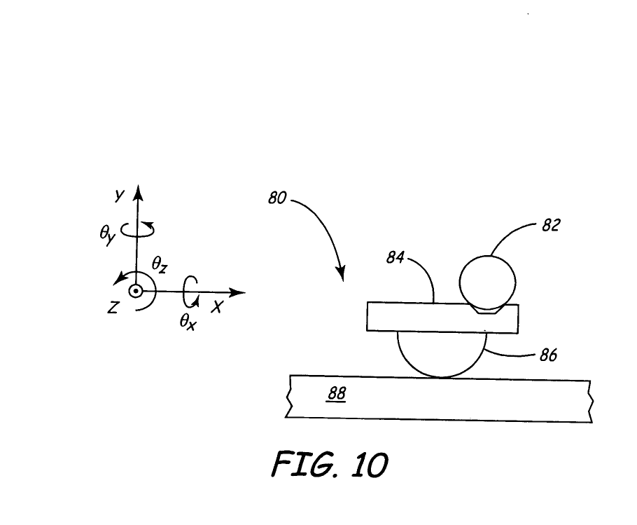

In another aspect, a pivot surface may engage the base directly. This is shown in FIG. 10. Optical alignment mount 80 includes component holder 84 and spherically shaped pivot 86. Pivot 86 engages base 88. Example optical component, lens 82, is secured to component holder 84. The height of lens 82 in the Y direction is adjusted by pivoting component holder 84 in the θ_{Z} direction. The position of lens 82 may also be adjusted in the X, Z, θ_{X}, and θ_{Y} directions by moving component holder 84 in the X, Z, θ_{X}, and θ_{Y} directions, respectively. Pivot 86 may be secured to base 88 by appropriate bonding material such as adhesive or solder. Pivot 86 and base 88 may be of appropriate materials, or a combination of materials, such as metal, glass, ceramic, semiconductor, or plastic and have coatings to facilitate bonding. In a further aspect, pivot 86 and base 88 are made of metal such as stainless steel, Kovar, or Invar. Pivot 86 may then be secured to base 88 by resistance welding or laser welding.

Although the present invention has been described with reference to the preferred embodiments, workers skilled in the art will recognize that changes may be made in form and detail without departing from the sprit and scope of the invention. Other optical components such as lenses, detectors, and light sources may be accurately aligned with the present invention. A number of optical components may be pre-assembled together and then aligned as a single unit with the present invention. Other optical devices such as fiber optic demultiplexers and optical amplifiers may use the optical alignment mount of the present invention. Pivot surfaces need not be spherical or cylindrical, but should be curved to allow the height of an optical component to be adjusted as the component mount is pivoted. Component mounts may have sockets and pivot supports may have pivot surfaces. Sockets may be made by anisotropically etching properly oriented single crystal silicon.

The present invention enables optical components to be raised or lowered during alignment by pivoting the optical component mount. Solid support between the pivot surface and socket is maintained during this height adjustment as well as the alignment of the optical component in other degrees of freedom. Accordingly, alignment errors caused by post-bond shifts are substantially reduced.

What is claimed is:

1. An optical alignment mount for adjusting a height of an optical component relative to a substrate comprising:
a component mount adapted to receive an optical component, the component mount having a pivot surface; and
a pivot support configured to engage the pivot surface of the component mount to change the height of the optical component relative to the substrate.

2. The optical alignment mount of claim 1 wherein the pivot support includes a socket.

3. The optical alignment mount of claim 2 wherein the socket comprises a v-groove.

4. The optical alignment mount of claim 3 wherein the component mount includes a cylindrically shaped pivot surface.

5. The optical alignment mount of claim 2 wherein the socket comprises a hole.

6. The optical alignment mount of claim 5 wherein the component mount includes a spherical pivot surface.

7. The optical alignment mount of claim 6 wherein the hole is chamfered.

8. The optical alignment mount of claim 1 including a bonding material to fixedly secure the component mount to the pivot support.

9. The optical alignment mount of claim 8 wherein the bonding material comprises an adhesive.

10. The optical alignment mount of claim 9 wherein the bonding material comprises solder.

11. The optical alignment mount of claim 1 wherein the component mount is welded to the pivot support.

12. The optical alignment mount of claim 1 wherein the light which interacts with the optical component is directed generally parallel to a plane of the substrate.

13. The optical alignment mount of claim 12 wherein the light couples to another optical component mounted to the substrate.

14. An optical alignment mount for adjusting a height of an optical component relative to a substrate comprising:
an optical component mount with a curved pivot surface and adapted to receive an optical component, the center of curvature of the pivot surface defining a pivot point; and
a pivot support adapted to engage the pivot surface of the optical component mount to change the height of the optical component relative to the substrate.

15. The optical alignment mount of claim 14 wherein the optical component is offset from the pivot point.

16. The optical alignment mount of claim 14 wherein the curved pivot surface is cylindrically shaped.

17. The optical alignment mount of claim 14 wherein the curved pivot surface is spherically shaped.

18. The optical alignment mount of claim 14 wherein the pivot support includes a socket.

19. The optical alignment mount of claim 17 wherein the socket comprises v-groove.

20. The optical alignment mount of claim 17 wherein the socket comprises a hole.

21. The optical alignment mount of claim 14 including a bonding material, the bonding material fixedly securing the optical component mount to the pivot support.

22. The optical alignment mount of claim 20 wherein the bonding material comprises an adhesive.

23. The optical alignment mount of claim 20 wherein the bonding material comprises solder.

24. The optical alignment mount of claim 14 wherein the optical component mount is fixedly secured to the pivot support.

25. The optical alignment mount of claim 14 wherein the light which interacts with the optical component is directed generally parallel to a plane of the substrate.

26. The optical alignment mount of claim 25 wherein the light couples to another optical component mounted to the substrate.

27. An optical alignment mount for adjusting a height of an optical component relative to a substrate comprising:
an optical component mount adapted to receive an optical component and further having a socket; and
a pivot support with a curved pivot surface configured to engage the socket of the optical component mount to change the height of the optical component relative to the substrate.

28. A method of adjusting a height of an optical component relative to a substrate comprising:
obtaining an optical component mount adapted to receive an optical component;
placing the optical component mount in a pivot support;
pivoting the optical component mount in the pivot support to change the height of the optical component relative to the substrate.

29. The method of claim 28 wherein the optical component mount has a spherical surface.

30. The method of claim 28 including fixing the optical component mount to fix the optical component at a desired height.

31. The method of claim 30 wherein fixing comprising bonding.

32. The method of claim 28 wherein the light which interacts with the optical component is directed generally parallel to a plane of the substrate.

33. The method of claim 32 wherein the light couples to another optical component mounted to the substrate.
